(19) United States
(12) Patent Application Publication
(10) Pub. No.: US 2008/0077701 A1
(43) Pub. Date: Mar. 27, 2008

(54) Synchronized data content delivery

(76) Inventors: George Philip Kongalath, St-Laurent (CA); Anna Anthony, St-Laurent (CA); Bradley Mills, Deux-Montagnes (CA)

Correspondence Address: Alex Nicolaescu;Ericsson Canada Inc., Patent Department, 8400 Decarie Blvd., Town Mount Royal, QC, H4P 2N2, US

(21) Appl. No.: 11/527,484

(22) Filed: Sep. 27, 2006

(51) Int. Cl. G06F 15/16

(52) U.S. Cl. 709/232; 709/231

(57) ABSTRACT

Methods, data servers, signal and destination device for optimizing asynchronous delivery of a data content. Once it is determined that more than one instances of the data content are asynchronous, attempts are made to merge them into a fewer number of synchronized instances. It is done by providing a synchronization instance before delivering the synchronized instance and the synchronization instance of the data content. The synchronization instance may be consumed first while the synchronized instance is stored in cache. Thereafter, the synchronized instance is consumed from the cache upon completion of the synchronization instance. Alternatively, the synchronization instance may have an accelerated bit rate and be consumed while it is being received and stored in cache. The synchronized instance is thereafter consumed upon completion of the synchronization instance. The signal comprises information enabling identification of a transition point between the synchronization instance and the synchronized instance of the data content.

### TECHNICAL FIELD

The present invention relates to data content delivery and, more particularly, to synchronizing data content delivery to multiple destinations.

### BACKGROUND

The television broadcasting industry is under transformation. One of the agents of change is television transmission over Internet Protocol (IPTV). In IPTV, a television viewer receives only selected contents. IPTV covers both live contents as well as stored contents. The playback of IPTV requires either a personal computer or a “set-top box” (STP) connected to an image projection device (e.g., computer screen, television set). Video content is typically an MPEG2 or MPEG4 data stream delivered via IP Multicast, a method in which information can be sent to multiple computers member of a group at once. In comparison, in legacy over the air television broadcasting, a user receives all contents and selects one via a local tuner. Television broadcasting over cable and over satellite follows the same general principle using a wider bandwidth providing for a larger choice of channels.

In IPTV, the content selection of live contents is made by registering an address of the viewer to a multicast group using standardized protocols (e.g., Internet Group Management Protocol (IGMP) version 2). Live contents include the typical over the air, cable or satellite contents. For content selection of stored contents (Video on demand (VOD)), a unicast stream is sent to the address of the viewer using standardized protocols (e.g., Real Time Streaming Protocol (RTSP)). A third type of content, time-shifted, can be placed in one of the two preceding categories. It is a live content sent via multicast if the time-shifted content is provided at a fixed time and, thus, is a delayed repetition of a previous multicast stream. It is a stored VOD content if the time-shifted content is offered on demand to the viewers via unicasts streams.

A problem associated with VOD contents is the multiplication of unicast streams, associated with a single stored VOD content, initiated within a finite period of time to multiple destinations. This rapidly consumes bandwidth in the network from the content source to the content destination.

The problem described in terms of IPTV in the preceding lines is also present in other technologies where a data feed is to be distributed or made available to more than one end user. For instance, similarities may be readily observed with other on-demand TV or audio contents such as Mobile TV, High Definition Digital content, Digital Video Broadcasting Handheld (DVBH), various radio streaming, MP3 streams, private or public surveillance systems streams (audio or video or audio-video), etc. Some other examples also include a given file in high demand (new software release, software update, new pricing list, new virus definition, new spam definition, etc.). In such a case, multiple transfers of a single file or content (e.g., File Transfer Protocol (FTP) transfers) may be initiated within a finite period of time, which create the same kind of pressure on the network from the source to the destination. There could also be other examples of situation in which a similar problem occurs such as, for example, transfer of updated secured contents to multiple sites within a definite period of time (e.g., using secured FTP or a proprietary secured interface) for staff-related information, financial information, bank information, security biometric information, etc.

As can be appreciated, it would advantageous to be able to optimize the network use for content transfers being initiated within a finite period of time. The present invention aims at providing at least a portion of the solution to the problem.

### SUMMARY

A first aspect of the present invention relates to a method for optimizing asynchronous delivery of a data content. The method comprises the steps of determining that more than one instances of the data content are asynchronous, merging at least two of the more than one determined instances into one synchronized instance of the data content, providing at least one synchronization instance of the data content to synchronize the merged instances and delivering the synchronized instance of the data content and the synchronization instance of the data content. The synchronized instance of the data content represents at least a portion of the data content and the synchronization instance of the data content represents at least portion of the data content.

A second aspect of the invention relates to a method for sending a data content from a server over a network to a plurality of destinations. The method comprises the steps of receiving a first request for the data content from a first one of the plurality of destinations, starting delivery of a first instance of the data content from the server for the first one of the plurality of destinations, subsequently to the reception of the first request, receiving a second request for the data content from a second one of the plurality of destinations and, following reception of the second request, starting delivery of a synchronization instance of the data content from the server for second one of the plurality of destinations. The first instance and the synchronization instance each represents at least a portion of the data content.

A third aspect of the present invention relates to a transmission transition signal for instructing a destination thereof to stop using a first transmission and start using a second transmission. The first and second transmissions are portions of a data content. The signal comprises an identification of the destination, an identification of the data content and a position indication identifying a transition point in the data content. The signal may further comprise a source identification, an identification of the first and the second transmissions or a location of at least one of the first and the second transmissions.

A fourth aspect of the present invention relates to a data server for optimizing asynchronous delivery of a data content. The data server comprises an optimization function and a communication module. The optimization function determines that more than one instances of the data content are asynchronous, merges at least two of the more than one determined instances into one synchronized instance of the data content, and provides at least one synchronization instance of the data content to synchronize the merged instances. The synchronized instance of the data content represents at least a portion of the data content and the synchronization instance of the data content represents at least portion of the data content. The communication module delivers the synchronized instance of the data content and the synchronization instance of the data content.

A fifth aspect of the present invention relates to a data server for sending a data content over a network to a plurality of destinations. The data server comprises a communication module that receives a first request for the data content from a first one of the plurality of destinations, starts delivery of a first instance of the data content for the first one of the plurality of destination, and following reception of the second request, starts delivery of a synchronization instance of the data content for second one of the plurality of destinations. The first instance representing at least a portion of the data content and the synchronization instance representing at least a portion of the data content.

The data server may further comprise an optimization function that, following reception of the second request, determines synchronization characteristics of a synchronized instance for the first and second ones of the plurality of destinations based on the time difference between the first and second requests.

A sixth aspect of the present invention relates to a destination device of a data content capable of receiving optimized synchronous data delivery of the data content. The destination device comprises a communication module, an accumulating device and a data content consumption function. The communication module receives a first and a second instances of the data content, wherein the first and the second instances of the data content together represent at least the complete data content. The accumulating device comprising a cache stores the first instance of the data content. The data content consumption function consumes the first instance and, past a transition point, consumes the second instance.

The data content consumption function may further consume the first instance while the second instance is being stored in cache and consume the second instance from the cache when the first instance is completed.

Alternatively, the data content consumption function may further consume the first instance while the first instance keeps being received and stored in cache and consume the second instance when the first instance is completed.

The communication module may further receive a transition transmission signal that comprises information enabling identification of the transition point.

### BRIEF DESCRIPTION OF THE DRAWINGS

A more complete understanding of the present invention may be gained by reference to the following ‘Detailed description’ when taken in conjunction with the accompanying drawings wherein:

FIGS. 1A, 1B and 1C each shows an exemplary network architecture supporting the present invention;

FIG. 2 is an exemplary time scale of distribution of a data content to an exemplary set of destinations in accordance with the teachings of the present invention;

FIG. 3 is an exemplary nodal operation and flow chart of a synchronized instance establishment in accordance with the teachings of the present invention;

FIG. 4 is a first exemplary flow chart of an algorithm of asynchronous instances determination in accordance with the teachings of the present invention;

FIG. 5 is a second exemplary flow chart of an algorithm of asynchronous instances determination in accordance with the teachings of the present invention;

FIG. 6 is an exemplary representation of a signal exchanged in accordance with the teachings of the present invention;

FIG. 7 is an exemplary modular representation of a data server in accordance with the teachings of the present invention; and

FIG. 8 is an exemplary modular representation of a data content's destination device in accordance with the teachings of the present invention.

### DETAILED DESCRIPTION

The current invention presents a solution to provide one data content over a network while reducing the number of asynchronous instances or transmissions of the data content. The solution includes determining that more than one instances of the data content are or will be asynchronously transmitted (e.g. a plurality of unicast transmissions). The objective is to merge the asynchronous instances into a fewer number of synchronized instances (e.g. one or more multicast transmissions) being delivered over the network. One or more synchronization instances (e.g., synchronization unicast transmission) could be required to ensure that the delivered data content is complete. There are two main optional scenarios. In a first scenario, a given destination uses the synchronization instance (e.g., unicast transmission) directly while a buffer, memory or cache capacity is used to store the synchronized instance (e.g, multicast transmission). Once the synchronization transmission is completely consumed, the destination uses the synchronized transmission from the cache. In a second scenario, following beginning of the delivery of a first instance (e.g., multicast transmission with only one registered destination), the synchronization instance (e.g., unicast transmission) is sent at a higher bit rate then the first instance. Once the destination of the synchronization instance have received at least as much as the first instance, the first instance and the synchronization instance are merged into the synchronized instance (e.g., the destination of the synchronization instance is added to the first instance). For a given data content, a larger cache capacity provides wider synchronization possibility to the destination.

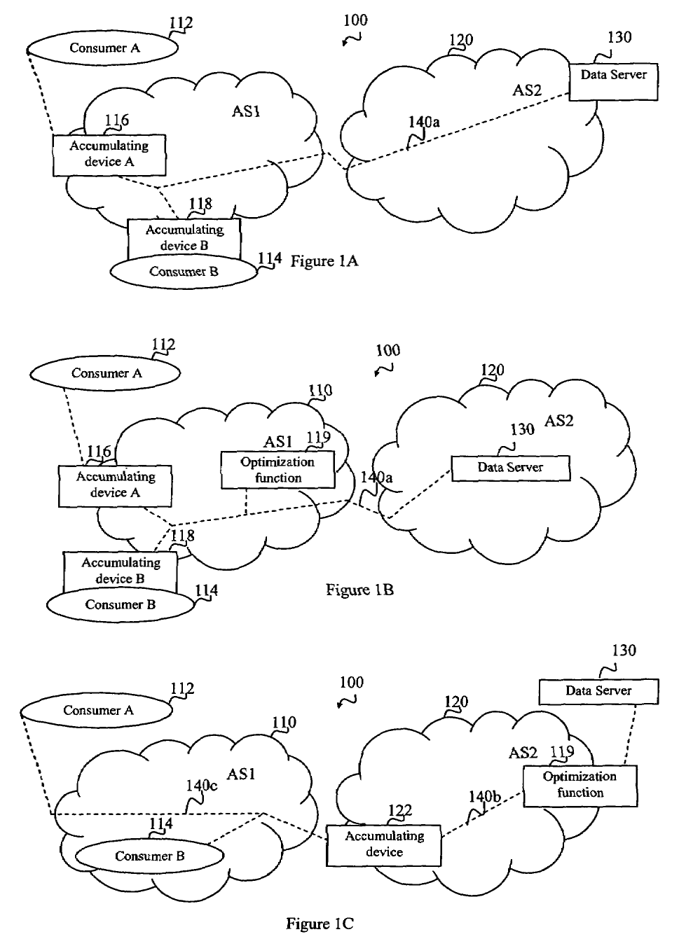

Reference is now made to the drawings, in which FIGS. 1A, 1B and 1C each shows an exemplary network architecture 100 supporting the present invention. FIGS. 1A, 1B and 1C show a first Administrative Domain (AS) 110 and a second AS 120. A data server 130 is shown on each of FIGS. 1A, 1B and 1C in different configurations. The data server 130 has different data contents made available (not shown). There are many different ways by which the data contents can be made available such as, for example, a Universal Resource Locator (URL) or Universal Resource Identifier (URI). In the three FIGS. 1A, 1B and 1C, one data content is being (or to be) delivered asynchronously to two destinations or consumers A 112 and B 114. A destination (e.g., A 112 and B 114) is defined, for the purpose of the present discussion, as an entity requiring or in need of the data content. As such, it could be a client device (workstation, personal computer, mobile phone, Personal Digital Assistant (PDA), etc.), a networked node (web server, etc.), an application or a file on the client device or the node, a database (or one or more records therein), a set-top box, a viewing device (TV or computer screen), etc. It should be readily understood that the working environment of the invention is not limited to one data server, two destinations or two AS, but that this represents a practical example to illustrate the teachings of the invention. Similarly, the links used between the data server 130 and the destinations A 112 and B 114 are not explicitly shown but are rather represented by dotted lines 140a-c as the invention is not restricted or bound to not any specific support. As examples, the invention could work over any physical support (e.g., wired, optical or wireless); any connection support (e.g., Ethernet, Asynchronous Transfer Mode (ATM), etc.); any network support (e.g. Internet Protocol (IP), Radio Resource Control (RRC), etc.); etc.

In the example of FIG. 1A, the destination A 112 is connected to the data server 130 through an accumulating device A 116. Similarly, the destination B 114 is shown collocated with an accumulating device B 118. The collocation of an accumulating device and its destination does not affect the teachings of the invention, but could be an interesting variant depending on the nature of the destination.

In the example of FIG. 1B, the destination A 112 is also connected to the data server 130 through the accumulating device A 116 and the destination B 114 is also shown collocated with the accumulating device B 118. FIG. 1B also shows an optimization function 119 located in the AS1 110. The optimization function 119 is an optional component of the invention that can provide support for the functions of the present invention, thereby minimizing or eliminating the need to adjust the data server 130 to provide the complete or partial functions itself. The potential of the optimization function 119 will be shown later. The optimization function 119 is positioned in the AS1 110 as an example and it should be readily understood that the Optimization function 119 could be located in the AS2 120 (see FIG. 1C), in collocation with the data server 130 or integrated in the hardware structure of the data server 130 FIG. 1A could be regarded as an example of such a possibility. For instance, the optimization function 119 could be a new module of the data server 130.

In the example of FIG. 1C, the destination A 112 and the destination B 114 are connected to the data server 130 through an accumulating device 122 located in the AS2 120. FIG. 1C also shows the optimization function 119 located in the AS1 110.

The accumulating devices 116, 118 and 122 can be used to buffer the data content for at least one of the destinations A 112 and B114 based on the time difference in the instances of the data content being (or to be) delivered thereto. Examples of accumulating device include a hard disk, any type of Random Access Memory (RAM) or other physical data support incorporated or not within the destination. The accumulating device may also represent a more complex and independent device such as a Digital Video Recorder (DVR), a Personal Video Recorder (PVR), a set-top box, a DVD reader and writer, a virtual hosting storage, an intermediate node, etc. A more detailed description of the accumulating devices is given below in relation to other figures.

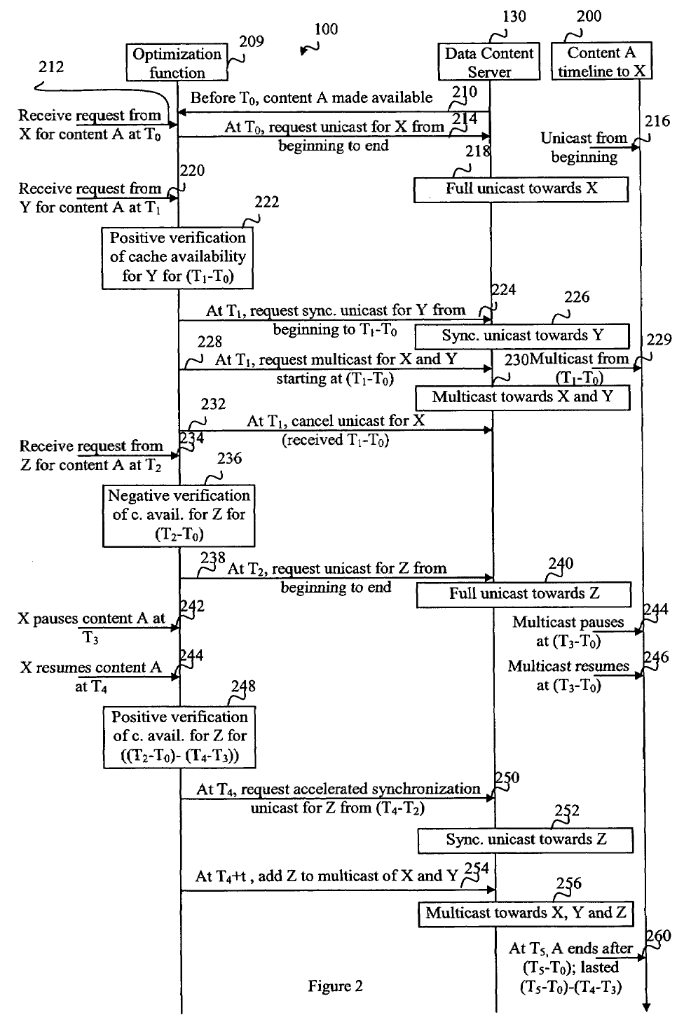

FIG. 2 shows an exemplary time scale of events related to distribution of a data content A to an exemplary set of destinations X, Y, Z (not shown) in accordance with the teachings of the present invention in the network 100. FIG. 2 is an example that could be applicable, for instance, in the context of a Video on Demand (VoD) data content. In the example of FIG. 2, an optimization function 209 is shown as an interaction point between the destinations X, Y and Z and the data server 130. A timeline of events as seen from the perspective of the destination X (200) is also shown.

FIG. 2 begins with data content A being made available (210) to at least X, Y and Z. Many ways of performing this task can be envisioned (and many are mentioned later on). At this stage of the example, knowing that X, Y and Z are able to access the data content A is sufficient. The present example assumes that the data content A is not currently being delivered to any destination.

The optimization function 209 thereafter receives a request for the data content A at T₀ from X (212). The optimization function 209 thereafter sends a request for a unicast delivery of the data content A from the data server 130 to X (214). Throughout the discussion, a unicast transmission could also be a multicast transmission subscribed to by only one destination (or to which only one destination is registered). The decision to send a multicast to only one destination could be taken by the optimization function 209 and sent in a corresponding request or could be decided by the data server 130 even if the request was formulated for a unicast transmission. The request 214 is for the data content A from the beginning to the end (or complete), which is herein chosen to simplify the example of FIG. 2, but is not a limitation to the working of the invention as is readily apparent later on. Still in hopes of simplifying the presentation of the example of FIG. 2, the request 214 is shown as sent at T₀. However, delays caused by many factors (the optimization function 209 processing, network delays, etc.) could occur and be taken into consideration by present invention (shown later).

Once received, the request 214 triggers delivery of the data content A from the data server 130 towards X into a unicast transmission (step 218, event 216). For simplicity, the unicast transmission 218 is shown as starting at T₀, even though delays are likely to occur between the request and beginning of the delivery. As mentioned earlier, such delays can be taken into consideration (shown later).

At a later time T₁, the optimization function 209 receives a request for the data content A from Y (220). The optimization function 209 then determines that the data content A is already being delivered to X (e.g., the optimization function 209 may have kept record of the requests 212 and/or 214 or may be involved in the actual delivery 218). Thus, the optimization function 209 tries to minimize the resources used in the network 100 by verifying the possibility of merging the deliveries to X and Y (e.g., in a multicast transmission) while affecting the experience of X or Y as little as possible. At this point, X already received and consumed the data content A from T₀ to T₁. Thus, merging the deliveries to X and Y while minimizing impacts on X requires starting the delivery of the merged (or multicast) transmission at time T₁. If the multicast transmission is started at T₁, Y needs to receive the data content A sent from T₀ to T₁ and consume this portion first (e.g., live from the data server 130) before consuming the multicast transmission received starting at T₁. Hence, Y needs to be able to store the multicast transmission of the data content A starting at T₁ for an amount of data corresponding to a length of the data content A of (T₁-T₀). In this example, it is assumed that the remaining length of the data content A is longer than (T₁-T₀). If it is shorter, then the minimum cache availability needed corresponds to the remaining length of the data content A. In some implementations, the verification of cache availability may not be needed, not possible or not beneficial and the optimization function 209 may therefore assume that Y has sufficient cache availability (e.g., for some types of data contents, for some types of accumulating devices, for some transfer protocol, etc.).

If the optimization function's 209 verification of cache availability for Y is positive (or assumed positive) (222), the optimization function 209 sends a requests for a unicast delivery of the data content A from the data server 130 to Y (214) to the data server 130 (224). The request 224 is for the data content A from the beginning to T₁-T₀. At T₁, the data server 130 initiates the requested unicast toward Y (226). The optimization function 209 also sends a request for multicast of the data content A from the data server 130 to X and Y starting at T₁-T₀ thereby merging the deliveries to X and Y (228). The request 228 is executed at the data server 130 (step 230, event 231). If the original request 214 for delivery of the complete data content A from the data server 130 to X was sent or executed as a multicast transmission, the request for multicast 228 or the execution thereof 230 would mean adding Y to the original transmission to X. If the original transmission to X was a unicast transmission, it can be cancelled (232) at this point as X receives the data content A from the multicast to X and Y.

At a later time T₂, the optimization function 209 receives a request for the data content A from Z (234). At this point, to benefit from the present invention, Z needs to be able to store the data content A starting at T₂ for an amount of data corresponding to a length of the data content A of (T₂-T₀). In the present example, it is specified that the optimization function 209 comes to a negative verification of the cache availability in Z. Therefore, the optimization function 209 sends a request for a unicast delivery of the data content A from the data server 130 to Z (238). The request 238 is for the data content A from the beginning to the end (or complete) and triggers delivery of a unicast transmission to Z (240).

At T₃, the optimization function 209 receives an indication that X paused its consumption of the data content A (242, event 244). As X is the destination that is the first consumer, the complete multicast transmission can be paused without affecting other destinations (i.e. Y). If the pause is long enough (or amounts to a stop of the transmission to X), the transmission would resume after a period of T₁-T₀ as Y would then need new content. However, the present example specifies that the optimization function 209 receives an indication that X resumed its consumption of the data content A at T₄ (242, event 244). Suspending the multicast transmission enables Y and Z to catch up on X no new content is sent between from T₃ and T₄.

The optimization function 209 can initiates a new verification of cache availability for Z. The new verification could be triggered by the fact that the characteristics of the multicast transmission is changed or could be triggered periodically for various reasons (e.g; the data content A may get closer to the end and necessitate less cache; the cache being dynamically used, space could now be available; removes the need for tracking various statuses of multiple concurrent transmission; etc.).

The example of FIG. 2 shows a positive verification 248, at T₄, of cache availability in Z for storing the multicast transmission of the data content A starting at T₄ for an amount of data corresponding to a length of the data content A of ((T₂-T₀)-(T₄-T₃)). However, instead of proceeding with the addition of Z to the existing multicast, the optimization function 209 sends a request for a synchronization unicast from the data server 130 to Z starting at T₄-T₂ at an accelerated bit rate in comparison to the bit rate of the multicast to X and Y (250). The data server 130 sends the requested unicast to Z (252). Because the bit rate of the synchronization unicast 252 is accelerated, Z consumes the data content A at a lower rate then its rate of arrival. The excess is stored in cache. After a certain period ‘t’, the data content A from the synchronization unicast 252 and stored in cache matches the multicast to X and Y. The duration of the period ‘t’ depends on the bit rates difference. After ‘t’, the optimization function 209 sends a request for multicast to X, Y and Z (254). The data server 130 adds Z to the multicast transmission already being delivered to X and Y (256). Z stores the multicast transmission in cache upon reception following the already stored synchronization unicast, deleting overlapping portion as needed to avoid duplication of portions of the data content A. The optimization function 209 can then cancel (not shown) the synchronization unicast transmission to Z if it was not already requested only for the period ‘t’ or slightly longer. At T₅, the data content A ends for X. Y and Z will continue to consume the data content A from their respective cache.

The example shown on FIG. 2 in relation to the addition of Y and Z to the multicast transmission uses two different approaches. The two approaches achieve substantially the same objective while being based on different technical characteristics. The choice of implementing either ones or both approaches is to be based on the characteristics of the data content A, the characteristics of the network equipments involved, the network 100 it self, the characteristics of the protocols used for the various transmissions, the characteristics of the destinations' cache, etc.

Other possibilities not shown on FIG. 2 would have been to receive a new request for the data content A from a new destination W after T₂ and to merge delivery to W and Z into a second multicast transmission. The destinations of the second multicast transmission could then be periodically assessed for merger with the original multicast shown on FIG. 2.

The example of FIG. 2 shows the optimization function 209 as an independent function. It should be noted that the tasks performed by the optimization function 209 could also be performed in the data server 130. While this could eliminate the need for some of the intermediates messages and requests, it may require further modifications to the data server's 130 original logic. The optimization function 209 could also be added as a module to an already existing node's hardware architecture, (e.g., the data server 130, a profile database (not shown), etc.).

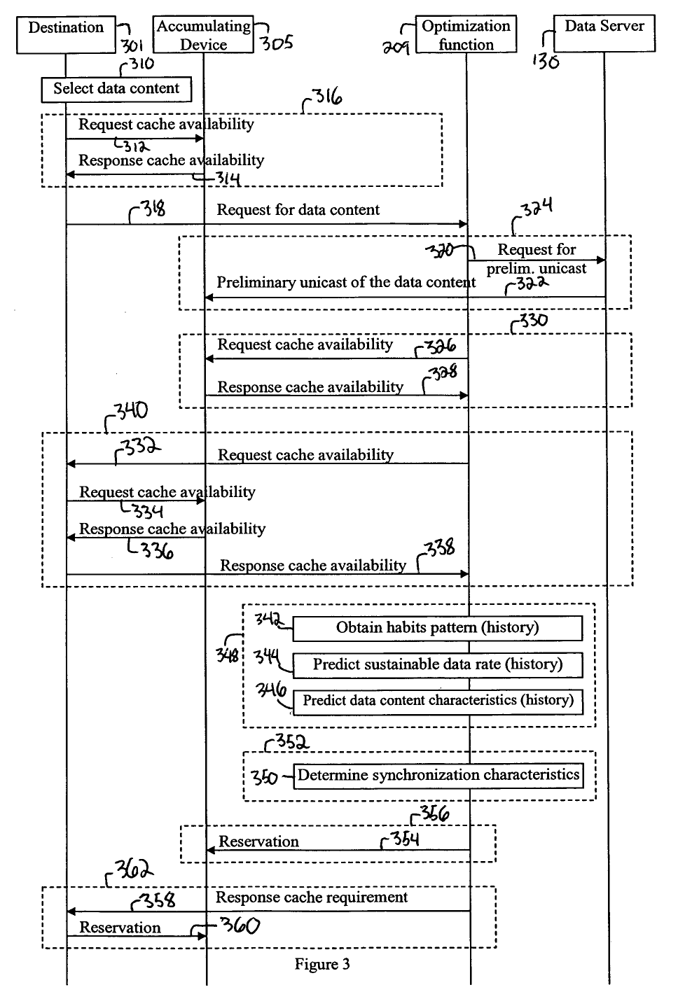

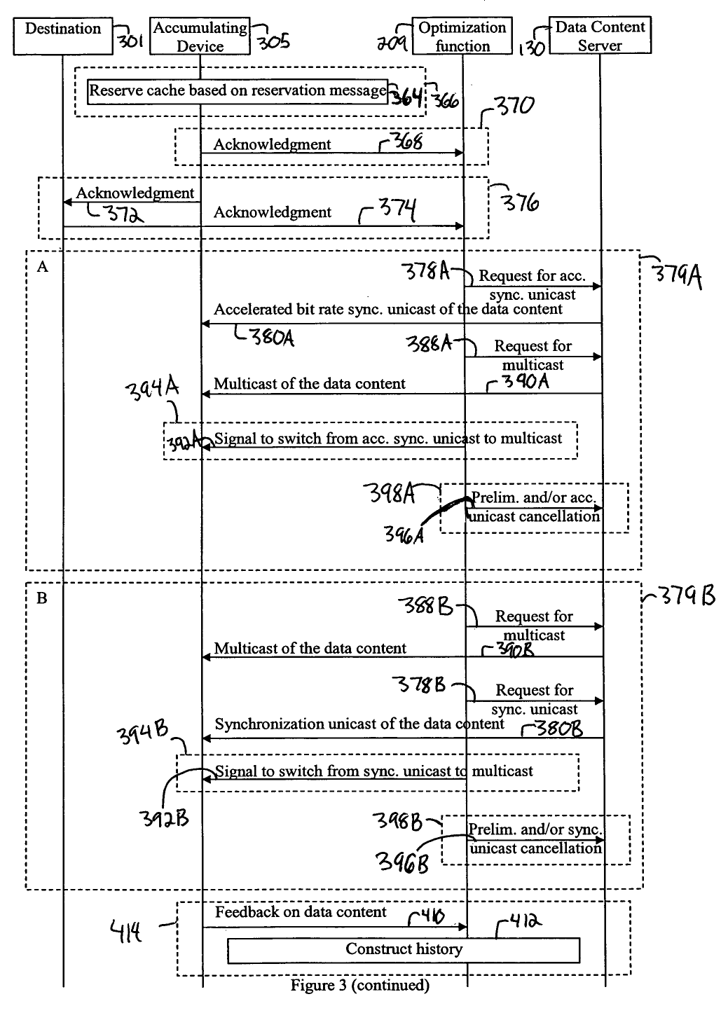

FIG. 3 shows an exemplary nodal operation and flow chart of a synchronized instance establishment in accordance with the teachings of the present invention. FIG. 3 shows multiple dashed boxes 316, 324, 330, 340, 348, 352, 356, 362, 366, 370, 376, 394A, 394B, 398A, 398B and 414 that each contains optional actions that are pertinent depending on the context of utilization of the invention.

FIG. 3 shows a destination 301 independent from an accumulating device 305. An optimization function 209 is also shown independent from the data server 130. In order for the exemplary implementation of FIG. 3 to remain as generic as possible, nodes are shown as separate entities. It should however be understood that, for instance, the destination 301 and the accumulating device 305 (forming what could be called the client or consumer side) could be collocated, that the optimization function 309 and the data server 130 (forming what could be called the provider side) could be collocated and that the optimization function could be collocated with another node (not shown) of the network 100.

A first step executed at the destination 301 consists of selecting a data content 310. Only one destination 301 is shown on FIG. 3 for simplicity, but it is assumed that the data server 130 is already serving other destinations (not shown) in the network 100 with the selected data content. Implicitly on FIG. 3 (but explicitly on FIG. 2), this requires that the data server 130 have at least one data content made available (not shown). The availability as such could be public (e.g., unprotected) or private (e.g., protected by password, by access rights managed on the data server 130, etc.). The data server 130 may publicise a list of data contents available therefrom (not shown). The list may be composed, for instance, of one or more web pages (e.g., HTTP, HTTPS, Flash®, etc.) containing various URL or URI related to data contents (e.g., complete file, complete TV show, complete movie etc.) or portions of data contents (e.g., TV content from a classic cable TV (CATV) channel for a specific period of the day, portion of a file, portion of a database content, etc.). Such web pages could be provided directly from the data server 130 or could be maintained on one or more other servers referencing the data server 130. The list may also be provided by specific applications or protocols that take care of building a list of available data contents (e.g., File Transfer Protocol (FTP) server side executed on the data server 130, internet bots or mobile agents, etc.). Another option may be for the client side to obtain one or more identifiers of data contents provided by the data server 130 from another entity (e.g., an email, a short or multimedia message, a paper letter, etc.) (not shown) before selecting the related data content in the step 310. Yet another option of execution of the step 310 of selecting a data content could be could be for the client side to build a request corresponding to at least a portion of the data server's 130 content (e.g., Standardized Query Language (SQL) query, Lightweight Directory Access Protocol (LDAP) query, etc.). It should also be mentioned that the optimization function 209, if used, can act as a proxy of the data server 130 and receive requests addressed to the data server 130 on its behalf. The optimization function 209 may further be the entity acting on behalf of the data server 130 in the examples above. Alternatively, the optimization function 209 may publicise the information as if it had control over the data content and take necessary actions towards the data server 130 on behalf of the client side.

Once the destination 301 has selected the data content in the step 310, the destination 301 needs to request the data content (step 318) to be delivered from the data server 130. The request 318 could specify another destination than the destination 301 as its intended reception point. Likewise, the request 318 may be made for a future delivery of the selected data content (e.g, a request made via a cellular phone at lunch time for a data content to be delivered on a TV set at home during the evening). Furthermore, the request 318 may be made for more than one data contents as a planning of the next data contents to be delivered (e.g., sequentially or at specified times). Additionally, the request 318 may be sent from the optimization function 209 on behalf of the destination 301 or accumulating device 305 thereby making the present invention transparent to the data server 130. The same proxying could be used for all interactions between the client side and the data server 130.

Before the step 318 of requesting the data content, the destination 301 may request cache availability from the accumulating device 305 (step 312). The accumulating device 305 replies to the request 312 with a response 314 comprising its cache availability (optional steps 316). Of course, the optional steps 316 are interesting only if the destination 301 cannot directly access the properties of the accumulating device 305, which is likely to be the case if the destination 301 and the accumulating device 305 are collocated. Similarly, the steps 316 are not interesting if the destination 301 is not aware that the cache availability information is beneficial for the provider side in the context of the present invention. Even if the destination 301 is aware that cache availability could be useful, the information on such availability may not be needed in the context of the request 318 (e.g, depending on the protocol of transmission used). If the steps 316 are executed or if the destination 301 is aware of the cache availability information of the accumulating device 305, the cache availability information can be included in the request for the data content 318.

The request 318 is received at the optimization function 209, which processes it. The processing of the request 318 presents multiple options explicated below. The optional steps 324 consist in requesting a preliminary transmission (320) from the data server 130 to the destination 301 to avoid delaying the delivery of the selected data content thereto. Upon reception of the request 320, the data server 130 sets up the preliminary transmission of the selected data content (322) towards the destination 301. The preliminary transmission is likely to be a complete unicast transmission of the selected data content. It could also be a complete multicast transmission to which only the destination 310 is (yet) registered. In the event of reception of concurrent requests 318, more destinations could also register to the multicast transmission. The preliminary transmission could also be a partial transmission as it is meant to avoid delaying delivery, but is likely to be replaced or complemented later on during the course of the complete delivery of the selected data content.

The preliminary transmission is shown on FIG. 3 as received directly at the accumulating device 305. This is done for clarity and simplicity purposes, but the actual delivery of the selected data content could reach the destination 301 directly without involving the accumulating device 305. The delivery of the selected data content could also pass through the destination 301 before reaching the accumulating device 305. The accumulating device 305 and the destination 301 may further be in different locations without affecting the teachings of the invention. Finally, in the event that the selected data content reached the accumulating device 305, a step of sending the delivered data content from the accumulating device 305 to the destination 301 is needed and not shown on FIG. 3. The step of sending the delivered data content from the accumulating device 305 to the destination 301 is likely to be made by sending the delivered data content from the cache of the accumulating device 305 in a First In First Out (FIFO) manner. The same comments concerning the interactions between the accumulating device 305 and the destination 301 can apply to all transmissions shown on FIG. 3 (e.g., 322, 380A, 390A, 390B and 402B, which are described further below).

If the cache availability information was received in the request 318, the optional steps 330 and 340, which present two different ways of obtaining such information at the optimization function 209, are not likely to be executed. They may still be executed if time elapsed between the request 318 and the steps 330 or 340 is long enough (which depends on the implementations) or if the received cache availability information is judged not reliable by the optimization function 209. The steps 330 consist in sending a request for cache availability (326) from the optimization function 208 directly to the accumulating device 305, which replies with a cache availability response (328). The steps 340 consist in sending a request for cache availability (332) from the optimization function 208 to the destination 301, which forwards it into a request (334) to the accumulating device 305. The accumulating device 305 replies to the destination 301 with a cache availability response (336), which is forwarded therefrom into a response (338) to the optimization function 209. The steps 340 may be necessary compared to the steps 330 if the accumulating device 305 is not accessible to the network 100 (e.g., located behind a firewall of the destination 301). As mentioned earlier, the cache availability information can be useful in determining whether or not synchronization of concurrent deliveries is possible, but it may not be needed at all depending on the selected data content's nature (e.g., not needed for text FTP transfers, etc.) or characteristics (e.g., overall size too small, etc.), or depending on the characteristics of its delivery (e.g., transferred via User Datagram Protocol (UDP), etc.).

Other information could also be gathered by the optimization function 209 as shown in the optional steps 348. The steps 348 could be related to acquisition of historical information concerning previous deliveries of data content(s) to the destination 301 (342). Such information could be stored at the optimization function 209 (see steps 414) or could be fetched from other databases (e.g., Home Location Register (HLR), Home Subscriber Server (HSS), etc.). The steps 348 could also be related to acquisition of historical information concerning previous deliveries of the selected data content to all destinations (346). As a last example shown on FIG. 3, the steps 348 could be related to acquisition of historical information concerning the status of the network 100 (e.g., sustainable bit rate, available bandwidth or other Quality of Service (QoS) characteristics, restrictions or possibilities from Service Level Agreement (SLA), etc.).

The optimization function 209 may thereafter determine characteristics of the synchronization (step 352, 350). The determination 352 is based on potentially gathered information (steps 316, 330, 340 and/or 348) and on characteristics of existing deliveries of the selected data content. The result of the determination 352 is likely to be a position indication in the selected data content corresponding to a potential point of synchronicity (i.e. potentially reachable point of merger of the presently asynchronous delivery). For instance, the position indication could be calculated based on the maximum bit rate achievable in the network 100 compared to the existing time difference between existing delivery(ies) and upcoming delivery from the request 318 (or existing preliminary transmission 322), taking into account the amount of data per time unit (or bit rate) of the selected data content. The position indication could be, for instance, a time index relative to the selected data content (from beginning or end), a proportion of the selected data content (already delivered or to be delivered), a size of the selected data content (already delivered or to be delivered), a frame number of the first frame of the selected data content (to be delivered or already delivered), etc. The determination 352 may further include a verification of synchronization feasibility by comparing the position indication characteristics against the cache availability information obtained from the accumulating device 305 in steps 316, 330 and/or 340. If such a verification is negative, the synchronization may be cancelled. If the preliminary transmission 322 was instantiated, it can be made permanent and complete (as needed). If the preliminary transmission 322 is not present, steps similar to the steps 324 can be performed by the optimization function 209 and the data server 130 to ensure usual transmission of the selected data content to the destination 301 (not shown). Thereafter, there could periodic new verifications of cache availability towards the accumulating device 305 during the usual transmission as cache usage is dynamic. New verifications could also be triggered by network events (e.g., negative such as delays or positive such as release of network resources, etc.).

If the verification performed in the determination 352 is positive or not performed (could be seen as the verification assumed positive), the optimization function 209 may try to reserve cache in the accumulating device 305 (step 354, 356 or steps 362) to increase the likelihood of proper delivery completion of the selected data content at the destination 301. Similarly to the steps 330, the reservation 354 is shown as sent directly to the accumulating device while the steps 362 are similar to the steps 340 as the reservation (or cache requirement) (358) is sent to the destination 301, which forwards it to the accumulating device 305 into a reservation (360). The reservation 354, 360 contains the amount of cache (e.g., size, time length, etc.) to be reserved for the selected data content. It may further comprise an indication of the time at which the reservation should occur (in n hours, minutes or seconds or at 12h34, etc.). The reservation 354, 360 may further contain further information concerning the selected data content that could enhance the upcoming delivery (e.g., expected bit rate, expected duration, expected delay, expected overlap between an eventual synchronization transmission (see 322, 380A or 402B) and an eventual synchronized transmission (390A or 390B), expected point of transition between the synchronization transmission and the synchronized transmission (see 394A, 394B, 601), etc.).

The reservation 354, 360 may further include the cache availability requests of steps 316, 330 or 340 meaning that it would require reservation for an amount of cache and also request cache availability information at once. This could be useful if the cache availability is insufficient to fulfil the reservation 354, 360. The cache availability thereby acquired could be used to synchronize the instance of the selected data content to be delivered to the destination 301 with other currently delivered instances of the selected data content.

The accumulating device 305 may, following reception of the reservation 354, 360, reserve a certain amount of cache based on the reservation 354, 360 (step 364, 366). The actual reservation 364 in the accumulating device may not be necessary for all implementations of the present invention (e.g., given the low percentage that the reservation 364 would represent on the overall cache availability, given the nature of the accumulating device, etc.). The accumulating device may further acknowledge the reservation 364 (or its lack of necessity) by sending a direct reservation acknowledgement towards the optimization function 209 (368, 370) or via the destination 301 (steps 376) with an indirect reservation acknowledgement (372) sent to the destination 310, which forwards it into a further reservation acknowledgement (374) towards the optimization function 209. The acknowledgement 368, 374 may indicate that the cache amount required by the reservation 354, 360 is available or what cache amount is actually available for the reservation 354, 360 (could be greater or smaller than the cache amount required by the reservation 354, 360). In the latter case, it would then be up to the optimization function 209 to determine if the synchronization can go on anyhow (e.g., by changing the bit rate of an eventual synchronization instance, etc.).

Past this point, the example of FIG. 3 presents two exemplary approaches A (379A) and B (379B) of the present invention that provides synchronization between multiple instances of the selected data content. In the two examples, the purpose is to merge the selected data content's asynchronous instances into a fewer number of synchronized instances.

In the first example A (379A), the optimization function 209 requests an accelerated synchronization transmission (378A) of the selected data content from the data server 130 for the destination 301. The request 378A may further comprise an indication of the bit rate of the accelerated synchronization transmission (e.g., relative or percentage, absolute number, etc.). The data server 130 responds to the request 378A by instantiating the accelerated synchronization transmission 380A (e.g., accelerated unicast transmission). The acceleration of the accelerated synchronization transmission 380A is measured in comparison to the bit rate of the selected data content already being delivered. The purpose of the accelerated synchronization transmission 380A is to fill-in the cache of the accumulating device 305 up to a point of synchronicity where the accelerated synchronization transmission 380A is delivering a same portion as the instance of the selected data content already being delivered (occurs after a certain time that depends on the bit rate difference). If the preliminary transmission 322 is still active before the request 378A, the request 378A could also be contain an indication to accelerate the bit rate of the preliminary transmission 322 thereby transforming it into the accelerated synchronization transmission 380A.

Once the point of synchronicity is reached in the first example A 379A, the optimization function 209 requests a new synchronized transmission (388A). The optimization function 209 also requests addition (not shown) of the destination(s) of the other instance(s) of the selected data content being synchronized. This addition request may be sent to the data server 130, but also be sent in accordance with other group delivery management protocol, which falls outside the scope of the present invention. If there is already an existing synchronized transmission 388A, then the optimization request 209 requests addition of the destination 301 thereto (not shown). The data server instantiates the synchronized transmission (if needed) (390A) and sends it to the appropriate address (e.g., multicast transmission).

At that moment, the destination 301 is using the selected data content from the cache of the accumulating device 305 as filled-in by the accelerated synchronization transmission 388A. Concurrently, the cache is being filled-in by the synchronized transmission 390A. In some implementation, the addition of the synchronized transmission 390A following the accelerated synchronization transmission 388A may be done seamlessly thereby minimising impact on the destination 301. To arrive at the same impact minimization, some implementations may require to actively indicate to the accumulating device 305 or the destination 301 when to accomplish a transition from the accelerated synchronization transmission 380A to the synchronized transmission 390A. This is the purpose of a signal (394A, 392A) sent from the optimization function 209. The signal 392A could also be sent from the data server 130 and may be addressed, as mentioned above, to the destination 301 or the accumulating device 305 (e.g., depending if the content is pushed from the accumulating device 305 to the destination 301 or pulled from the destination 301 to the accumulating device 305). The signal 392A may be sent near the transition point or may be sent beforehand indicating when the transition should occur.

Thereafter, the existing accelerated synchronization transmission (380A) and/or preliminary transmission (322) could be cancelled (398A) as they are not needed anymore.

In the second example B (379B), the optimization function 209 requests a synchronization transmission (378B) of the selected data content from the data server 130 for the destination 301 sent at a bit rate corresponding to the existing instance(s) of the selected data content. The request 378B may comprise a time limit corresponding to at least the time difference towards one of the existing instance of the selected data content. The optimization function 209 also requests a synchronized transmission (388B). The request 388B should be sent close to the request 378B, including before as shown on FIG. 3, or the eventual delay between the requests 388B and 378B should otherwise be taken into account in the time limit in the request 378B.

The data server 130 responds to the request 388B for the synchronized transmission similarly to the request 388A by instantiating the synchronized transmission 390B (see consideration above for 390A). The data server 130 responds to the request 378B for the synchronization transmission by instantiating a synchronization transmission 380B. The accumulating device or the destination 301 receives the synchronization transmission (378B) and the synchronized transmission (390B) of the selected data content from the data server 130 concurrently. The synchronization transmission (378B) shall be consumed first while the synchronized transmission (390B) is stored in cache. Once the synchronization transmission (378B) is completed, the synchronized transmission (390B) shall be consumed from the cache. In order to accomplish a proper transition from the synchronization transmission (378B) to the stored synchronized transmission (390B), a signal 394B, 392B may be used. The signal 392B is similar to the signal 392A.

Following completion of the selected data content, it could be helpful to accumulate historical information about the delivery (steps 414). Such information could be used as indicated in steps 348. The information could be sent as feedback on the data content (410) and used at the optimization function 209 to construct history (412).

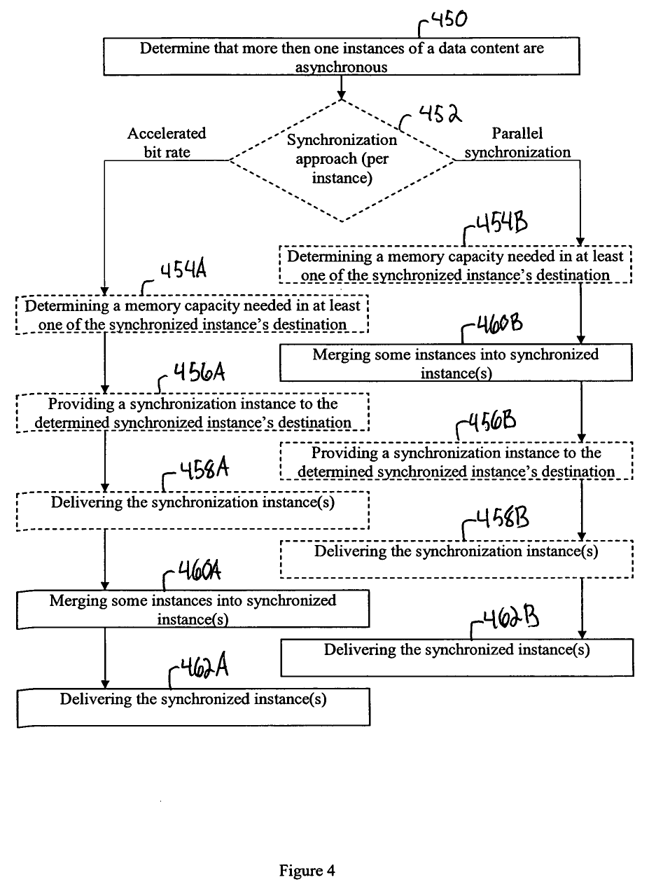

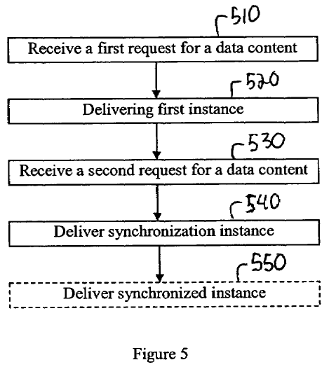

FIG. 4 shows a first exemplary flow chart of an algorithm of asynchronous instances determination in accordance with the teachings of the present invention. The algorithm starts by determining that more than one instances of the data content are asynchronous (450). This can translate, for instance, into receiving multiple requests for the same data content before being able to serve them or receiving a first request and starting the processing and receiving a second request for the same data content. It could also be a determination made concerning two instances already being delivered.

FIG. 4 shows two alternatives (452) to synchronizing the determined instances (the approaches could be mixed and applied differently for each instance). The same basic steps are necessary in both cases in a different order and with different implementation details (already explained above). In the case of the accelerated bit rate synchronization (scenario A) as in the case of the parallel synchronization (scenario B), it could be useful, while not mandatory as explained above, to obtain cache availability information before going further (454A, 454B).

Thereafter, the scenario A proceeds with providing at least one synchronization instance of the data content to synchronize the determined instances (456(A)). The synchronization instance of the data content represents at least a portion of the data content and is sent at an accelerated bit rate. The synchronization instances is(are) thereafter delivered (458A). Once it becomes possible (as explained above), at least two of the more than one determined instances are merged into one synchronized instance of the data content (460A) before being delivered (462A). The synchronized instance of the data content represents at least a portion of the data content.

Alternatively, the scenario B proceeds with merging at least two of the more than one determined instances into one synchronized instance of the data content (460B). The synchronized instance of the data content represents at least a portion of the data content. Thereafter, at least one synchronization instance of the data content is provided to synchronize the merged instances (456B). The synchronization instance of the data content represents a portion of the data content. The synchronized instance of the data content and the synchronization instance of the data content are then delivered (458B, 462B).

In the preceding example, merging at least two instances of the data content into one synchronized instance of the data content may further comprise determining characteristics of the synchronized instance of the synchronization instance based on characteristics of the instances to be merged. Fore instance, the characteristics of each of the instances to be merged may comprise a destination and a position indication. The position indication may be one of a time of instantiation, a time index relative to the beginning of the data content, a time index relative to the end of the data content, a proportion of the data content already delivered, a proportion of the data content to be delivered, a size of the data content already delivered, a size of the data content to be delivered, a frame number of the first frame of the data content to be delivered or a frame number of the last frame of the data content already delivered. The characteristics of the synchronized instance may comprise a multicast destination and a start position indication. The start position indication may consist of a time index relative to the data content, a proportion of the data content, a size of the data content or a frame number of the data content. The characteristics of the synchronization instance may comprise a destination and an end position indication. the end position may consist of a time index relative to the data content, a proportion of the data content, a size of the data content or a frame number of the data content. The characteristics of the synchronization instance may further comprise a start position indication that may consist of a time index relative to the data content, a proportion of the data content, a size of the data content or a frame number of the data content.

In the scenario B, in each of the at least one synchronization instance's destination, the synchronized instance is stored in a memory upon delivery and, upon completion of the synchronization instance, the synchronized instance is used from the memory.

The step 450 of determining that more than one instances of the data content are asynchronous may further comprises detecting a first request and, subsequently, a second request for instantiation of the data content. alternatively, the step 450 may comprise determining that the more than one instances are concurrently being delivered asynchronously. Another alternative for the step 450 of determining that more than one instances of the data content are asynchronous may comprise determining that a first instance and a second instance of the more than one instances will be concurrently delivered once delivery of the second instance begins. Yet another alternative for the step 450 of determining that more than one instances of the data content are asynchronous may be performed following an event in the network affecting delivery of at least one of the more than one instances of the data content. The affected instance could be a pre-existing synchronized instance.

FIG. 4 shows a second exemplary flow chart of an algorithm of asynchronous instances determination in accordance with the teachings of the present invention. The algorithm starts by receiving a first request for a data content from a first one of a plurality of destinations (510). Delivery of a first instance of the data content from the server for the first one of the plurality of destinations is thus started (520). The first instance represents at least a portion of the data content. Subsequently to the reception of the first request, a second request for the data content from a second one of the plurality of destinations is received (530). Following reception of the second request, delivery of a synchronization instance of the data content from the server for second one of the plurality of destinations is started (540). The synchronization instance represents at least a portion of the data content. The synchronization instance may be limited to a period corresponding to at least the time difference between the first and second requests.

The algorithm may continue with a step of, following reception of the second request, determining synchronization characteristics of a synchronized instance for the first and second ones of the plurality of destinations based on the time difference between the first and second requests before delivering the synchronized instance (550). The step 550 may further comprise processing history information related to the data content, the first or the second one of the plurality of destinations.

At the second one of the plurality of destinations, the synchronized instance is likely to be received at an accumulating device thereof. In such a case, at the accumulating device, the synchronized instance is stored in cache upon reception and the second one of the plurality of destinations consumes the synchronization instance before consuming the synchronized instance from the cache of the accumulating device.

The synchronization instance of the data content may be a multicast instance. In such an event, starting delivery of the synchronized instance of the data content (550) may comprise requesting addition of the second one of the plurality of destinations thereto thereby transforming the synchronization instance into the synchronized instance.

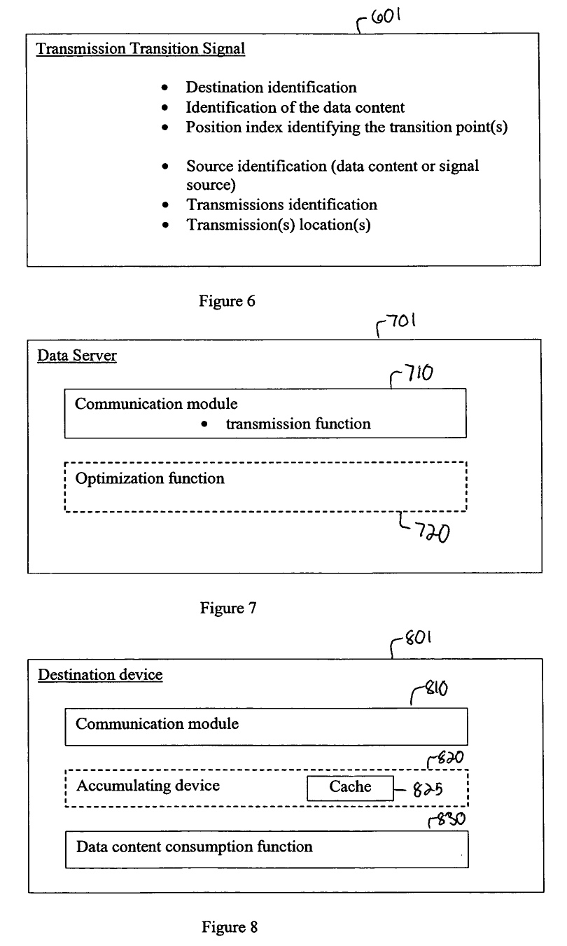

FIG. 6 shows an exemplary representation of a transmission transition signal 601 exchanged in accordance with the teachings of the present invention. The signal 601 is for instructing a destination thereof to stop using a first transmission and start using a second transmission. The first and second transmissions are portions of a single data content. The signal 601 comprises an identification of the destination, an identification of the data content and a position indication identifying a transition point in the data content. Optionally, the signal 601 may further comprise a source identification (data content identification and/or signal's source identification), one or more transmissions identification and one or more transmissions locations (e.g., local or remote).

FIG. 7 shows an exemplary modular representation of a data server 701 in accordance with the teachings of the present invention. The data server 701 may be for optimizing asynchronous delivery of a data content. The data server 701 comprises an optimization function 720 and a communication module 710. The optimization function 720 may determine that more than one instances of the data content are asynchronous, merge at least two of the more than one determined instances into one synchronized instance of the data content and provide at least one synchronization instance of the data content to synchronize the merged instances. The synchronization instance of the data content represents at least portion of the data content and the synchronized instance of the data content represents at least a portion of the data content. the communication module delivers the synchronized instance of the data content and the synchronization instance of the data content.

The data server 701 may also be for sending a data content over the network 100 to a plurality of destinations. In such a case, the communication module receives a first request for the data content from a first one of the plurality of destinations and starts delivery of a first instance of the data content for the first one of the plurality of destinations, the first instance representing at least a portion of the data content. Following reception of the second request, the communication module starts delivery of a synchronization instance of the data content for second one of the plurality of destinations. The synchronization instance representing at least a portion of the data content.

The optimization function 710 of the data server 701 may, following reception of the second request, determine synchronization characteristics of a synchronized instance for the first and second ones of the plurality of destinations based on the time difference between the first and second requests.

FIG. 8 shows an exemplary modular representation of a data content's destination device 801 in accordance with the teachings of the present invention. The destination device 801 is capable of receiving optimized synchronous data delivery of the data content. It comprises a communication module 810, an accumulating device 820 and a data content consumption function 830. The communication module 810 receives a first and a second instances of the data content. The first and the second instances of the data content together represent at least the complete data content. The accumulating device 820 comprises a cache 825 that stores the first instance of the data content. The data content consumption function 830 consumes the first instance and, past a transition point, consumes the second instance. The communication module 810 may further receive a transition transmission signal that comprises information enabling identification of the transition point.

The data content consumption function 830 may further consume the first instance while the second instance is being stored in cache and consumes the second instance from the cache when the first instance is completed. Alternatively, the data content consumption function 830 may further consume the first instance while the first instance keeps being received and stored in cache and consumes the second instance when the first instance is completed.

The preceding description provides a set of various examples applicable to various types of data content's instances to be synchronized. For instance, the types of data content include IPTV, other on-demand TV or audio contents such as Mobile TV, High Definition Digital content, Digital Video Broadcasting Handheld (DVBH), various radio streaming, MP3 streams, private or public surveillance systems streams (audio or video or audio-video), etc. Some other examples also include a given file in high demand (new software release, software update, new pricing list, new virus definition, new spam definition, etc.) (e.g., exchanged via File Transfer Protocol (FTP) transfers). There could also be other examples of situation in which a similar problem occurs such as, for example, transfer of updated secured contents to multiple sites within a definite period of time (e.g., using secured FTP or a proprietary secured interface) for staff-related information, financial information, bank information, security biometric information, etc.

In order to take various network delays into account, a systematic bias augmenting the length of the synchronization instances could be implemented. The transition signal could take this bias into account when indicating the transition point.

The innovative teachings of the present invention have been described with particular reference to numerous exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views and the various elements depicted are not necessarily drawn to scale.

1. A method for optimizing asynchronous delivery of a data content, the method comprising the steps of:
determining that more than one instances of the data content are asynchronous;
merging at least two of the more than one determined instances into one synchronized instance of the data content, wherein the synchronized instance of the data content represents at least a portion of the data content;
providing at least one synchronization instance of the data content to synchronize the merged instances, wherein the synchronization instance of the data content represents at least portion of the data content; and
delivering the synchronized instance of the data content and the synchronization instance of the data content.

2. The method of claim 1 wherein the step of merging at least two of the more than one instances of the data content into one synchronized instance of the data content further comprises determining characteristics of the synchronized instance based on characteristics of the at least two of the more than one instances and determining characteristics of the synchronization instance based on characteristics of the at least two of the more than one instances.

3. The method of claim 2 wherein the characteristics of each of the at least two of the more than one instances comprise at least a destination and a position indication, the position indication being selected from a group consisting of a time of instantiation, a time index relative to the beginning of the data content, a time index relative to the end of the data content, a proportion of the data content already delivered, a proportion of the data content to be delivered, a size of the data content already delivered, a size of the data content to be delivered, a frame number of the first frame of the data content to be delivered and a frame number of the last frame of the data content already delivered.

4. The method of claim 2 wherein the characteristics of the synchronized instance comprise a multicast destination and a start position indication selected from a group consisting of a time index relative to the data content, a proportion of the data content, a size of the data content and a frame number of the data content.

5. The method of claim 2 wherein the characteristics of the synchronization instance comprise a destination and an end position indication selected from a group consisting of a time index relative to the data content, a proportion of the data content, a size of the data content and a frame number of the data content.

6. The method of claim 5 wherein the characteristics of the synchronization instance further comprise a start position indication selected from a group consisting of a time index relative to the data content, a proportion of the data content, a size of the data content and a frame number of the data content.

7. The method of claim 1 wherein:
the step of determining that more than one instances of the data content are asynchronous further comprises, following a first request for a first one of the more than one instances, determining that at least a second request for at least a second one of the more than one instances is to be processed asynchronously from the first request;
the step of providing at least one synchronization instance of the data content further comprises providing the at least second one of the more than one instances as the at least one synchronization instance;
the step of delivering the synchronized instance of the data content and the synchronization instance of the data content is performed by delivering the synchronization instance at a bit rate higher than the synchronized instance; and
the step of merging into one synchronized instance of the data content further comprises merging the first instance and the at least second one of the more than one instances into the one synchronized instance of the data content.

8. The method of claim 7 wherein the step of merging into one synchronized instance is performed when the portion of the at least second one of the more than one instances being delivered has already been delivered via the first instance.

9. The method of claim 1 wherein the step of providing the at least one synchronization instance to synchronize the merged instances further comprises determining a memory capacity needed in each of the at least one synchronization instance's destination.

10. The method of claim 1 wherein the method further comprises, in each of the at least one synchronization instance's destination, storing the synchronized instance in a memory upon delivery and, upon completion of the synchronization instance, using the synchronized instance from the memory.

11. The method of claim 1 wherein the step of determining that more than one instances of the data content are asynchronous further comprises detecting a first request and, subsequently, a second request for instantiation of the data content.

12. The method of claim 1 wherein the step of determining that more than one instances of the data content are asynchronous further comprises determining that the more than one instances are concurrently being delivered asynchronously.

13. The method of claim 1 wherein the step of determining that more than one instances of the data content are asynchronous further comprises determining that a first instance and a second instance of the more than one instances will be concurrently delivered once delivery of the second instance begins.

14. The method of claim 1 wherein the step of determining that more than one instances of the data content are asynchronous is performed following an event in the network affecting delivery of at least one of the more than one instances of the data content, wherein the affected instance is a pre-existing synchronized instance.

15. A method for sending a data content from a server over a network to a plurality of destinations, the method comprising the steps of:
receiving a first request for the data content from a first one of the plurality of destinations;
starting delivery of a first instance of the data content from the server for the first one of the plurality of destinations, the first instance representing at least a portion of the data content;
subsequently to the reception of the first request, receiving a second request for the data content from a second one of the plurality of destinations; and
following reception of the second request, starting delivery of a synchronization instance of the data content from the server for second one of the plurality of destinations, the synchronization instance representing at least a portion of the data content.

16. The method of claim 15 further comprising a step of, following reception of the second request, determining synchronization characteristics of a synchronized instance for the first and second ones of the plurality of destinations based on the time difference between the first and second requests.

17. The method of claim 16 wherein the step of determining synchronization characteristics further comprises processing history information related to at least one of:
the data content;
the first one of the plurality of destinations; and
the second one of the plurality of destinations.

18. The method of claim 16 further comprising a step of starting delivery of a synchronized instance of the data content from the server.

19. The method of claim 15 wherein the synchronization instance is limited to a period corresponding to at least the time difference between the first and second requests.

20. The method of claim 18 further comprising the steps of:
at the second one of the plurality of destinations, receiving the synchronized instance at an accumulating device thereof;
at the accumulating device, storing the synchronized instance in cache upon reception; and
at the second one of the plurality of destinations, consuming the synchronization instance before consuming the synchronized instance from the cache of the accumulating device.

21. The method of claim 18 further comprising a step of cancelling the first instance of the data content following starting delivery of the synchronized instance.

22. The method of claim 18 wherein the first instance of the data content is a multicast instance.

23. The method of claim 22 wherein the step of starting delivery of the synchronized instance of the data content comprises requesting addition of the second one of the plurality of destinations to the first instance thereby transforming the first instance into the synchronized instance.

24. The method of claim 18 further comprising steps of, before starting delivery of the synchronized instance of the data feed content:
requesting cache availability for the second one of the plurality of destinations; and
receiving the cache availability.

25. The method of claim 24 wherein the step of starting delivery of the synchronized instance is performed only if the cache availability is suitable to store the synchronized instance for a period corresponding to at least the time difference between the first and second requests.

26. The method of claim 24 further comprising a step of, following reception of the cache availability, sending a cache reservation message to the second one of the plurality of destinations.

27. The method of claim 26 wherein the cache reservation message comprises an indication of at least one of a cache size and cache content duration to be reserved.

28. The method of claim 26 wherein the step of starting delivery of the synchronized multicast is performed only if a step of receiving a reservation acknowledgment message from the second one of the plurality of destinations is performed.

29. A transmission transition signal for instructing a destination thereof to stop using a first transmission and start using a second transmission, wherein the first and second transmissions are portions of a data content, the signal comprising:
an identification of the destination;
an identification of the data content; and
a position indication identifying a transition point in the data content.

30. The signal of claim 29 further comprising:
a source identification;
an identification of the first and the second transmissions; and
a location of at least one of the first and the second transmissions.

31. A data server for optimizing asynchronous delivery of a data content, the data server comprising:
an optimization function that:
determines that more than one instances of the data content are asynchronous;
merges at least two of the more than one determined instances into one synchronized instance of the data content, wherein the synchronized instance of the data content represents at least a portion of the data content; and
provides at least one synchronization instance of the data content to synchronize the merged instances, wherein the synchronization instance of the data content represents at least portion of the data content; and
a communication module that delivers the synchronized instance of the data content and the synchronization instance of the data content.

32. A data server for sending a data content over a network to a plurality of destinations, the data server comprising:
a communication module that:
receives a first request for the data content from a first one of the plurality of destinations;
starts delivery of a first instance of the data content for the first one of the plurality of destinations, the first instance representing at least a portion of the data content;
following reception of the second request, starts delivery of a synchronization instance of the data content for second one of the plurality of destinations, the synchronization instance representing at least a portion of the data content.

33. The data server of claim 32 further comprising an optimization function that, following reception of the second request, determines synchronization characteristics of a synchronized instance for the first and second ones of the plurality of destinations based on the time difference between the first and second requests.

34. A destination device of a data content capable of receiving optimized synchronous data delivery of the data content comprising:
a communication module that receives a first and a second instances of the data content, wherein the first and the second instances of the data content together represent at least the complete data content;
an accumulating device comprising a cache that stores the first instance of the data content; and
a data content consumption function that:
consumes the first instance and, past a transition point, consumes the second instance.

35. The destination device of claim 34 wherein the data content consumption function further consumes the first instance while the second instance is being stored in cache and consumes the second instance from the cache when the first instance is completed.

36. The destination device of claim 34 wherein the data content consumption function further consumes the first instance while the first instance keeps being received and stored in cache and consumes the second instance when the first instance is completed.

37. The destination device of claim 34 wherein the communication module further receives a transition transmission signal that comprises information enabling identification of the transition point.
